(19) United States
(12) Patent Application Publication
(10) Pub. No.: US 2002/0193346 A1
(43) Pub. Date: Dec. 19, 2002

(54) Method and mixture for protecting animals against pests

(75) Inventors: John S. Greeson, Dexter, NM (US); Eric H. Bonewitz, Overland Park, KS (US)

Correspondence Address: ROBERT W. BECKER & ASSOCIATES, 707 HIGHWAY 66 EAST, SUITE B, TIJERAS, NM, 87059, US

(73) Assignee: Dairy Solutions, LLC., Dexter, NM

(21) Appl. No.: 09/844,316

(22) Filed: Apr. 26, 2001

(51) Int. Cl. A01N 55/00; A01N 25/00; A01N 37/34; A01N 53/00

(52) U.S. Cl. 514/63; 424/405; 514/521; 514/531

(57) ABSTRACT

A mixture for application on an animal to provide protection against insects, parasites, arachnids and/or other anthropods, and ectoparasites and endoparasites in general, viruses, bacteria and/or other microorganisms is provided. The mixture includes a carrier, especially mineral oil, having a viscosity of from 150 to 600, and especially 225 to 450, centistokes. The mixture also includes an insecticide, ectoparasitide, endoparasitide, viricide and/or bacteriacide that is blended with the carrier.

### BACKGROUND OF THE INVENTION

The present invention relates to a mixture for application on an animal to provide protection against the negative effects of insects, parasites, arachnids, and/or other anthropods, and ectoparasites and endoparasites in general, viruses, bacteria and/or other microorganisms, all referred to generally as “pests” in this application. The present invention also relates to a method of protecting animals using such a mixture.

For direct application to animals, it is known to blend active ingredients such as insecticides, ectoparasitides and endoparasitides with oil or water based carriers. These carriers have a low viscosity, based on cost and in particular the ability of such a carrier to penetrate below the hair of an animal.

The carriers of heretofore known mixtures have a viscosity that allows the carrier to penetrate below the animal's hair since many active ingredients degrade substantially in UV light and therefore lose their efficacy relatively quickly. By using a low viscosity oil or water, the known products will penetrate under the surface hair of the animal and will thus reside on the animal out of the sunlight, with the animal's hair shading the product. This extends the life of the active ingredient on the animal. A low viscosity oil or water, once applied and below the surface hair and on the skin of the animal, also enhances the spread of the oil to increase the surface area of the animal being covered by the active ingredient.

A drawback of the heretofore known carriers is that they are not optimally effective in making the active ingredient available for the required contact with all pests of concern, since the active ingredient resides below the hair. Furthermore, this allows transdermal absorption of the active ingredient into the animal and hence possibly into the human food chain. In addition, the known products are not very resistant to water and run off during a rainstorm or when the animals are being sprayed or washed.

Examples of heretofore known compositions include U.S. Pat. No. 5,134,132 (Matthewson), U.S. Pat. No. 4,762,718 (Marks Sr.), U.S. Pat. No. 6,071,857 (Vogt et al.), U.S. Pat. No. 4,668,666 (Allan et al.) and U.S. Pat. No. 4,568,541 (Dorn et al).

It is therefore an object of the present invention to provide an effective animal protection mixture that also overcomes the drawbacks of heretofore known compositions.

### SUMMARY OF THE INVENTION

The method and mixture of the present invention for application on an animal to provide protection against pests, including anthropods such as ticks and insects, parasites, arachnids, and/or other anthropods, and ectoparasites and endoparasites in general, viruses, bacteria and/or other microorganisms, and are characterized primarily by a carrier having a viscosity of from 150 to 600 centistokes, with an insecticide, ectoparasitide, endoparasitide, viricide and/or bacteriacide being blended with the carrier to form the inventive mixture.

The mixture of the present invention is intended for application to an animal to protect the animal against the effects of pests, for example by killing or repelling them, or otherwise counteracting their effects. Furthermore, the inventive mixture, with the proper active ingredient(s) incorporated therein, can, when applied to an animal, regulate the growth of any of the aforementioned organisms, and/or can interrupt, interdict, or prevent their breeding or ovipositing cycle.

The critical feature of the inventive mixture is a carrier having a viscosity of from 150 to 600, especially 225 to 450 centistokes. The presently contemplated carrier is mineral oil in the stated viscosity range. One specific example of a suitable mineral oil is Teflo 30, which is manufactured by the Lyondell Company. This mineral oil has a viscosity of 300 centistokes. Other carriers, especially inert oil-based carriers, could also be utilized, as long as they fall within the stated viscosity range of from 150 to 600 centistokes, whereby an effective midrange viscosity would be 250-350 centistokes, with the presently preferred range being 300 to 350 centistokes.

The mixture of the present invention has a number of advantages. For example, in the case of insecticides and ectoparasitides, the mixture ensures that the carrier, and hence the active ingredient blended therein, essentially lay on top of an animal's coat of hair, thereby making the active ingredient easily transmissible to flies, lice, other parasites or insects, arachnids, and/or other anthropods, and ectoparasites and endoparasites in general, viruses, bacteria and/or other microorganisms when they land or are deposited on the animal. This is critical to ensuring a more efficient and more effective killing of target pests. Furthermore, since the active ingredient to a large extent resides on top of the hair rather than below the hair and on the skin of the animal, the potential for transdermal absorption of the active ingredients into the body of the animal is minimized. This in turn minimizes or prevents contamination of the human food chain.

The carrier of the inventive mixture has sufficient weight and mass so that when it is dispensed at a given pressure, for example by spraying, the proper spray pattern will be achieved to adequately cover the target animal. By way of example only, one suitable means for applying the inventive mixture is described in U.S. patent application, Ser. No. 09/342,046. However, due to the weight of the carrier, the spray will be far less affected by wind currents than is the case with known light weight carriers, which, along with the active ingredient carried thereby, tend to drift away when any wind is present and thus do not achieve the required contact with the target animal. In addition, thinner viscosity carriers are more apt to atomize when sprayed, and can thus freely drift in the air, providing a potential health hazard for animals and workers since breathing of most active ingredients is generally not acceptable. This drawback is minimized with the carrier of the present invention since such a carrier minimizes the potential for atomization and the attendant health hazards. The viscosity of the present invention optimizes the size of spray droplets and hence optimizes the spray pattern to achieve adequate application and coverage of a target animal. It should be noted that in the case of an endoparasitide, where transdermal absorption is important, the inventive mixture can be applied in a solid stream rather than a spray pattern to achieve penetration below the hair to the skin of the animal.

As indicated previously, the inventive carrier viscosity range keeps the mixture of the present invention on the surface of an animal, minimizing penetration below the hairline. This is important for ensuring that a target organism or pest comes into contact with the active ingredient of the mixture merely by landing on a treated animal. This overcomes the drawback of prior known mixtures, which penetrate below the outer layer of an animal's hair, so that a target organism is less likely to come into contact with the active ingredient. Although such a surface application exposes the mixture of the present invention to UV light, this is not a disadvantage because the mixture can be applied frequently enough on a routine basis, particularly with the equipment covered in the aforementioned patent application, since this system is automated and precludes the need for labor inputs associated with application of the mixture.

A carrier within the viscosity range of the present invention also minimizes run off and loss of active ingredient during rain storms or in situations where the animals are dosed with water either for cooling or cleaning them.

The inventive carrier viscosity range has the further advantage that the carrier itself tends to impart a physical “kill” mechanism. In particular, for example, flies pick up the carrier on their feet when they come into contact with the mixture. As the flies then “groom” themselves, they spread the oil over their air ducts and lungs and the flies suffocate because the mineral oil film that they deposit prevents the transfer of oxygen. Therefore, death can occur independently of the active ingredient.

The insecticide, ectoparasitide, endoparasitide, viricide and/or bacteriacide of the inventive mixture can, for example, be a pyrethroid, including permethrin, pyrethrin and cinerin, an organophostate or organopolysiloxane, ivermectin, eprinomectin, or any other suitable active ingredient.

### EXAMPLE 1

Pursuant to one specific example of the inventive mixture, the following were utilized:

| | % Active | % in Mix By Volume |
|---|---|---|
| Permethrin-Technical Grade | 97.70% | 1.024% |
| Piperonyl Butoxide-Technical | 99.98% | 1.000% |
| Mineral Oil (Teflo 30 or Equiv) + | | 97.976% |
| Other Inerts | | |
| Total | | 100.00% |

After the appropriate batch size was determined, the technical grade Permethrin was heated to 140° F. for six to eight hours and was lightly agitated. The Permethrin was then thoroughly blended with the Piperonyl Butoxide. The resulting solution was then mixed with white mineral oil having a viscosity of 300 to 375 centistokes; the mixture was vigorously stirred to achieve uniform blending. The mixture was then ready for packaging or application to an animal that was to be treated, for example by being sprayed onto the animal.

### EXAMPLE 2

Pursuant to one specific example of the inventive mixture, the following were utilized:

| | % Active | % in Mix By Volume |
|---|---|---|
| Permethrin-Technical Grade | 97.70% | 0.512% |
| Piperonyl Butoxide-Technical | 99.98% | 1.000% |
| Mineral Oil (Teflo 30 or Equiv) + | | 98.488% |
| Other Inerts | | |
| Total | | 100.00% |

### EXAMPLE 3

Pursuant to one specific example of the inventive mixture, the following were utilized:

| | % Active | % in Mix By Volume |
|---|---|---|
| Permethrin-Technical Grade | 97.70% | 0.512% |
| Piperonyl Butoxide-Technical | 99.98% | 0.500% |
| Mineral Oil (Teflo 30 or Equiv) + | | 98.988% |
| Other Inerts | | |
| Total | | 100.00% |

Pursuant to the present invention, it is also optionally possible to incorporate a light reflective pigment within the inventive mixture. Such a pigment is designed to reduce the “heat gain” that an animal experiences from exposure to the sun by reflecting a significant portion of the light spectrum responsible for heat gain. Reduction of this heat gain reduces the amount of energy an animal must expend in cooling itself, and also reduces the level of heat stress that the animal experiences from exposure to sunlight. In addition, and this is of particular importance with lactating dairy cows, a further benefit of the reflective pigment is that since it reduces heat gain by the animal, less body moisture is expelled by the cow in its natural cooling process; this moisture can be redirected to the lactating function of the cow, thereby increasing the volume of milk production.

Furthermore, the heat gain which leads to heat stress in animals, particularly dairy cows, tends to suppress the appetite of such animals. Therefore, reducing heat stress results in better feed consumption by an animal, resulting in weight gain and/or improved milk production. Heat stress also tends to suppress immuno functions in animals and can therefore lead to higher levels of disease in animals, especially dairy cows. Therefore, reducing the heat stress should also provide a positive effect upon the level of disease within herds and/or individual animals.

Suitable reflective pigments that can be added to the inventive mixture include, by way of example only, zinc oxide and titanium dioxide.

Many insecticides, ectoparasitides, endoparasitides, viricide and/or bacteriacide, in other words the active ingredients, are negatively affected by uvA and uvB light. In particular, light in the ultraviolet spectrum causes certain active ingredients to break down or to be otherwise altered in such a way that they become less effective or even totally ineffective for their stated purpose. Therefore, in order to extend the life of the inventive mixture, it is optionally also possible to incorporate UV blockers and/or absorbers into the mixture. By extending the effective life of the active ingredient or ingredients, less frequent application and/or lower dosage levels to an animal are required, thereby also lowering the overall expense of applying such a mixture. Such an additive or inhibitor can again be zinc oxide or titanium dioxide, although for this use the particle size may have to be smaller than is the case for the light reflective pigment in order to achieve optimal results. Such smaller particles could be incorporated within the mixture in combination with larger particles of the same or another component, thereby optimizing both light reflective and uV blocking and/or absorbing properties of the mixture

The present invention is, of course, in no way restricted to the specific disclosure of the specification and Examples, but also encompasses any modifications within the scope of the appended claims.

What I claim is:

1. A mixture for application on an animal, to provide protection against pests, comprising:
a carrier having a viscosity of from 150 to 600 centistokes; and
at least one of an insecticide, ectoparasitide, endoparasitide, viricide, and bacteriacide with said carrier.

2. A mixture according to claim 1, wherein said carrier is an oil-based carrier.

3. A mixture according to claim 2, wherein said oil-based carrier is mineral oil.

4. A mixture according to claim 1, wherein said carrier is a chemically inert carrier.

5. A mixture according to claim 1, that further includes a pigment.

6. A mixture according to claim 5, wherein said pigment has at least one of the properties of being light reflective, and uvA and uvB blocking or absorptive.

7. A mixture according to claim 5, wherein said pigment is selected from the group consisting of zinc oxide and titanium dioxide.

8. A mixture according to claim 1, wherein said at least one insecticide, ectoparasitide, and endoparasitide is selected from the group consisting of pyrethroids, organopolysiloxanes, organophosphates, ivermectin and eprinomectin.

9. A mixture according to claim 8, wherein said at least one insecticide and ectoparasitide is permethrin or pyrethrin.

10. A mixture according to claim 1, wherein said viscosity is 225 to 450 centistokes.

11. A mixture according to claim 10, wherein said viscosity is 300 to 350 centistokes.

12. A method of protecting an animal against pests, said method including the steps of:
providing a carrier having a viscosity of from 150 to 600 centistokes;
mixing at least one of an insecticide, ectoparasitide, endoparasitide, viricide, and bacteriacide with said carrier to provide a mixture; and
applying said mixture to an animal.

13. A method according to claim 12, wherein said step of applying comprises spraying or pouring said mixture onto an animal.

14. A method according to claim 12, wherein said carrier is mineral oil.

15. A method according to claim 12, wherein said at least one insecticide, ectoparasitide, and endoparasitide is selected from the group consisting of pyrethroids, organopolysiloxanes, organophosphates, ivermectin and eprinomectin.

16. A method according to claim 15, wherein said at least one insecticide and ectoparasitide is permethrin or pyrethrin.

17. A method according to claim 12, wherein said viscosity is 225 to 450 centistokes.
